(19) United States
(12) Patent Application Publication
(10) Pub. No.: US 2011/0296361 A1
(43) Pub. Date: Dec. 1, 2011

(54) CIRCUIT ANALYSIS METHOD

(75) Inventor: Masakazu TANAKA, Kyoto (JP)

(73) Assignee: PANASONIC CORPORATION, Osaka (JP)

(21) Appl. No.: 13/209,071

(22) Filed: Aug. 12, 2011

Related U.S. Application Data
(63) Continuation-in-part of application No. PCT/JP2010/000877, filed on Feb. 12, 2010.

(30) Foreign Application Priority Data
Feb. 13, 2009 (JP) 2009-031298

(51) Int. Cl. G06F 17/50

(52) U.S. Cl. 716/108

(57) ABSTRACT

A maximum delay of a combinational circuit is accurately reduced in consideration of a correlation between variations in delays of devices (transistors etc.) and interconnects. Circuit modification candidate information about a circuit modification candidate for improving a delay of a circuit to be designed is generated based on circuit information about the circuit to be designed, technology information about a distribution of a characteristic of a device and/or an interconnect based on a process to be designed, delay distribution information about a distribution of the delay in the circuit to be designed, and delay correlation information about a correlation between variations in the delay in the circuit to be designed.

### CROSS-REFERENCE TO RELATED APPLICATIONS

This is a continuation of PCT International Application PCT/JP2010/000877 filed on Feb. 12, 2010, which claims priority to Japanese Patent Application No. 2009-031298 filed on Feb. 13, 2009. The disclosures of these applications including the specifications, the drawings, and the claims are hereby incorporated by reference in their entirety.

### BACKGROUND

The present disclosure relates to the design of semiconductor integrated circuits, and more particularly, to methods for improving performance of a semiconductor integrated circuit by simulating characteristics of the circuit based on process information etc. using a computer.

In the design of semiconductor integrated circuits, the progress of miniaturization has increased an influence of process variations on circuit characteristics. Therefore, there have been techniques (hereinafter referred to as statistical delay analysis techniques) of representing variations in a delay in each element included in a semiconductor integrated circuit by a normal distribution, and estimating a delay distribution of the entire circuit using a statistical calculation.

A statistical delay analysis technique has been proposed in Japanese Patent Publication No. 2002-279012. In Japanese Patent Publication No. 2002-279012, a distribution of maximum delays can be statically calculated for a CMOS combinational circuit, taking into consideration correlations between delays of devices, interconnects, and paths.

FIGS. 3A and 3B show an example circuit to be designed. FIG. 4 shows an example acyclic graph G={V, E} representing the circuit of FIGS. 3A and 3B, where V represents a set of vertices in the graph and E represents a set of edges in the graph. As described in Japanese Patent Publication No. 2002-279012, the maximum values of a true maximum delay required to transmit a value 0 to an output terminal of the entire circuit and a true maximum delay required to transmit a value 1 to the output terminal may be calculated. A true maximum delay required to transmit the value 0 to each terminal v (21, 22) is represented by d0(v), and a true maximum delay required to transmit the value 1 to each terminal v (21, 22) is represented by d1(v).

Here, the input and output terminals of the entire circuit and the input and output terminals of logic gates correspond to vertices v in the graph. Each vertex v includes two vertices v0 and v1 in the graph. In FIG. 4, these pairs of vertices (v0, v1) are each enclosed by an ellipse (21, 22), where v0 is shown as an open circle (23) and v1 is shown as a closed circle (24). The vertices v0 and v1 indicate that the corresponding terminal v takes the signal value 0 or 1, respectively. The vertices v0 and v1 are hereinafter referred to as a 0-vertex and a 1-vertex of v, respectively.

A vertex corresponding to an input terminal of the entire circuit is referred to as a source, which has no incoming edge, and a vertex corresponding to an output terminal of the entire circuit is referred to as a sink, which has no outgoing edge. A set (25) of sources is represented by S and a set (26) of sinks is represented by T. A sequence of vertices from a source to a sink in the graph G is referred to as a path (or a directed path). In FIG. 4, each rectangle (27) represents a logic gate included in the circuit. A vertex (21) on the left side of a rectangle corresponds to an input terminal of the corresponding logic gate, and a vertex (22) on the right side of the rectangle corresponds to an output terminal of the corresponding logic gate. An edge (28) in a rectangle leaves a vertex representing an input of the logic gate to a vertex representing an output of the logic gate. When the rectangle represents a NAND gate or a NOR gate, the edge corresponds to a pMOS or an nMOS in the gate. An edge linking vertices included in different rectangles corresponds to an interconnect. An edge e0 leaving a 0-vertex enters another 0-vertex, and an edge e1 leaving a 1-vertex enters another 1-vertex.

The maximum delays d0(v) and d1(v) of each terminal v of the circuit are caused to correspond to maximum path lengths d(v0) and d(v1) from a sink to the O-vertex (v0) and 1-vertex (v1) of the vertex v in the graph G, respectively. Therefore, for each edge e=(u, v) where u and v represent the start vertex and end vertex of the edge, a delay required to transfer a signal value from u to w is given as a weight t(e) for the edge e.

By performing simulation using such an acyclic graph, delays in a logic circuit can be analyzed by a relatively simple procedure.

On the other hand, Japanese Patent Publication No. 2007-304957 describes a technique of improving a circuit based on a finding that there is a correlation between the probability distributions of a delay time and a transition time input to each cell. Specifically, delay information is calculated by delay distribution calculation means, and timing analysis is performed based on the delay information.

However, in order to improve the design performance of LSI, it is necessary to accurately find and improve a device or interconnect which has an influence on a critical path delay. To this end, it is necessary to accurately estimate the probability that each device or interconnect becomes a portion of a critical path.

When a signal f is calculated in the circuit of FIGS. 3A and 3B, then if the signal transfer times (delays) of a signal d and a signal e largely depend on the delay of a signal b, there is a high correlation between the delay of the signal d and the delay of the signal e. If there are variations in interconnect delay, there is also a correlation between signal transfer delays of the fan-out of the signal b. Therefore, a statistical delay analysis technique which is performed without consideration of these correlations is highly likely to lack accuracy. If the accuracy of estimation of a delay distribution is low, a semiconductor integrated circuit needs to be designed so that normal operation is guaranteed even if a number of worst conditions which actually have almost no probability of occurrence simultaneously occur, and therefore, an unreasonably large design margin is required. Therefore, the cost (e.g., area, power consumption, etc.) of the designed semiconductor integrated circuit becomes unreasonably high.

On the other hand, Japanese Patent Publication No. 2007-304957 describes a technique of accurately calculating a delay distribution using a correlation information between a delay and an input transition time etc. However, when circuit improvement candidates are selected, a correlation between path delays cannot be taken into consideration. In other words, no matter how much the accuracy of analysis of a delay distribution is increased, the circuit improvement cannot be accurately performed, and therefore, only a delay improvement effect that is smaller than an estimation is obtained in delay distribution calculation after circuit modification. If the circuit modification and the delay distribution calculation are repeatedly performed an excessive number of times, the design period increases, or f the circuit is excessively modified, the area or power consumption of the semiconductor integrated circuit becomes unreasonably high.

### SUMMARY

The present disclosure describes implementations of a technique of accurately reducing the maximum delay of a combinational circuit in consideration of a correlation between variations in delays of devices (transistors etc.) and interconnects.

An example circuit analysis method according to the present disclosure is a method for analyzing a semiconductor integrated circuit, comprising obtaining circuit information about a circuit to be designed, obtaining technology information about a distribution of a characteristic of a device and/or an interconnect based on a process to be designed, obtaining delay distribution information about a distribution of a delay in the circuit to be designed, obtaining delay correlation information about a correlation between variations in the delay in the circuit to be designed, and generating circuit modification candidate information about a circuit modification candidate for improving the delay in the circuit to be designed, based on the circuit information, the technology information, the delay distribution information, and the delay correlation information.

According to the example circuit analysis method, a circuit modification candidate for improving the delay in the circuit to be designed can be accurately estimated, whereby cost, such as an area, power consumption, etc., can be reduced.

According to the present disclosure, a portion of a circuit to be improved is extracted in consideration of delay correlation information in order to reduce a maximum delay or correct a delay constraint violation, whereby an improvement candidate can be more accurately estimated. Specifically, the number of times of circuit improvement to achieve correction of the delay constraint violation can be advantageously reduced, or the cost, such as an area, power consumption, etc., can be reduced to a greater extent in a semiconductor integrated circuit at the time that the circuit improvement is completed.

### BRIEF DESCRIPTION OF THE DRAWINGS

FIG. 1 is a diagram showing a flow of a process performed based on a circuit analysis program.

FIG. 2 is a diagram showing a flow of design of a semiconductor integrated circuit.

FIGS. 3A and 3B are diagrams showing example circuit information about a circuit to be designed.

FIG. 4 is a diagram showing an acyclic graph representing the circuit of FIGS. 3A and 3B.

FIG. 5 is a diagram showing an acyclic graph representing the circuit of FIGS. 3A and 3B.

FIG. 6 is a diagram showing an acyclic graph representing the circuit of FIGS. 3A and 3B.

FIG. 7 is a diagram showing example technology information.

FIG. 8 is a diagram showing example delay distribution information.

FIG. 9 is a diagram showing example delay distribution information.

FIG. 10 is a diagram showing example delay correlation information.

FIG. 11 is a diagram showing example delay correlation information.

FIG. 12 is a diagram showing example circuit modification candidate information.

FIG. 13 is a diagram showing example circuit modification candidate information.

FIG. 14 is a diagram showing a flow of a process performed in a circuit modification candidate extraction process.

FIGS. 15A and 15B are diagrams showing circuit information after modification is performed by a circuit improvement process.

FIGS. 16A-16C are diagrams showing example circuit information after modification is performed by the circuit improvement process.

FIG. 17 is a diagram showing a variation of the flow of the process performed based on the circuit analysis program.

FIG. 18 is a diagram showing a variation of the flow of the process performed based on the circuit analysis program.

FIG. 19 is a diagram showing a variation of the flow of the process performed based on the circuit analysis program.

FIG. 20 is a diagram showing a variation of the flow of the process performed based on the circuit analysis program.

FIG. 21 is a diagram showing a variation of the flow of the process performed based on the circuit analysis program.

FIG. 22 is a diagram showing a variation of the flow of the process performed based on the circuit analysis program.

### DETAILED DESCRIPTION

Preferred embodiments will be described hereinafter with reference to the accompanying drawings.

A circuit analysis program according to this embodiment may be stored in an information processing apparatus (e.g., a PC etc.), and a server apparatus which can be used by a terminal apparatus via a network. The program may be recorded and distributed in the form of various recording media, such as a CD-ROM, a DVD-ROM, a flash memory, etc. If the recording medium is loaded into and read out by an information processing apparatus, such as a PC etc., or the program is previously stored in a storage medium included in an information processing apparatus and is read out when necessary, a function relating to the program can be carried out. A flow of a process performed based on the program will be described hereinafter.

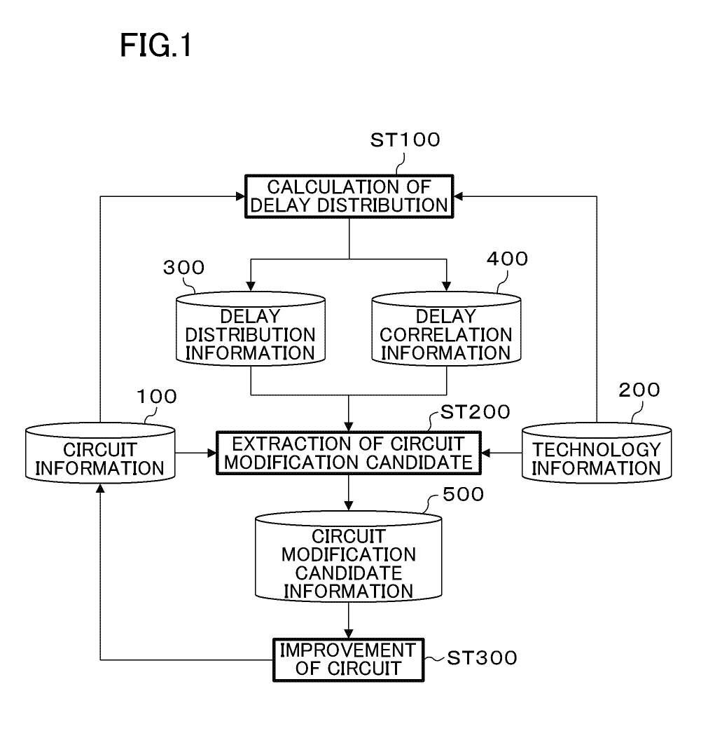

FIG. 1 shows a flow of a process performed based on the circuit analysis program of this embodiment. A computer which executes the circuit analysis program has, as a database, circuit information 100, technology information 200, delay distribution information 300, delay correlation information 400, and circuit modification candidate information 500. The computer uses these information items to perform a delay distribution calculation process ST100, a circuit modification candidate extraction process ST200, and a circuit improvement process ST300, thereby modifying the original circuit information 100.

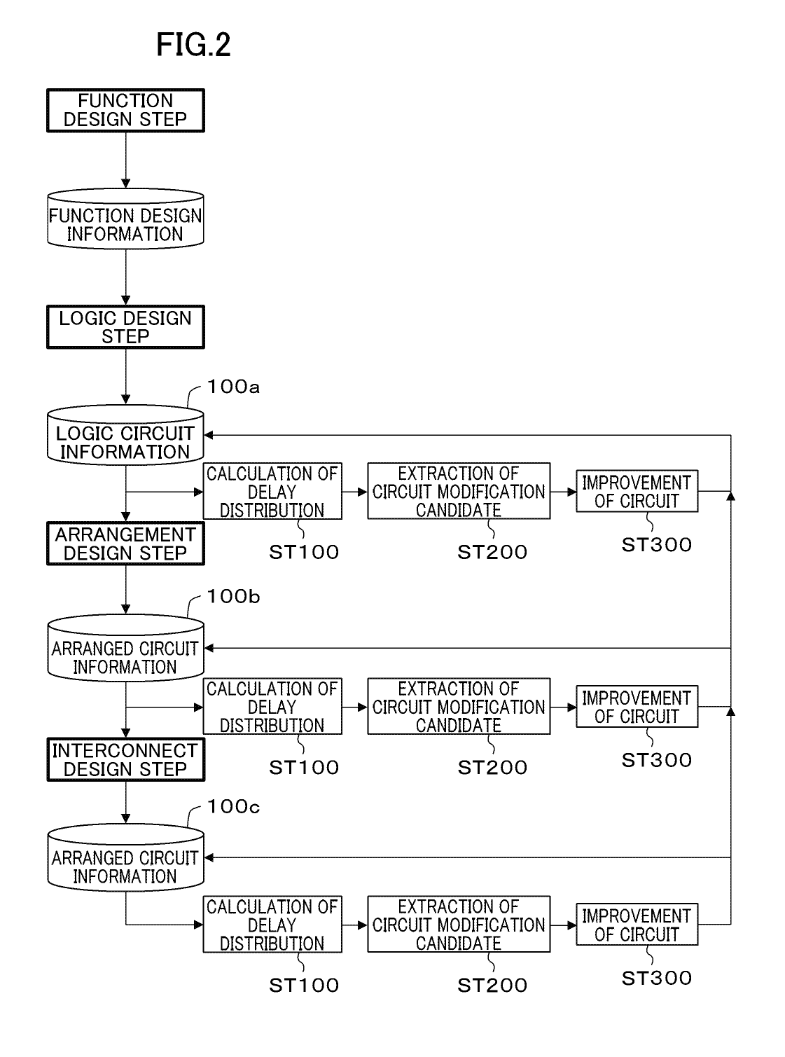

FIG. 2 shows a flow of designing a semiconductor integrated circuit. In this embodiment, as the circuit information 100 of FIG. 1, the following layout information items may be used: logic circuit information 100a which is generated by logic synthesis in the logic design step of FIG. 2; arranged circuit information 100b which is generated after arrangement design in an arrangement design step; interconnected circuit information 100c which is generated after interconnect design in an interconnect design step; etc. When the arranged circuit information 100b is used, not only the original arranged circuit information 100b, but also the original logic circuit information 100a, can be modified by the circuit improvement process ST300. When the interconnected circuit information 100c is used, not only the original interconnected circuit information 100c, but also the original logic circuit information 100a and the arranged circuit information 100b, can be modified by the circuit improvement process ST300.

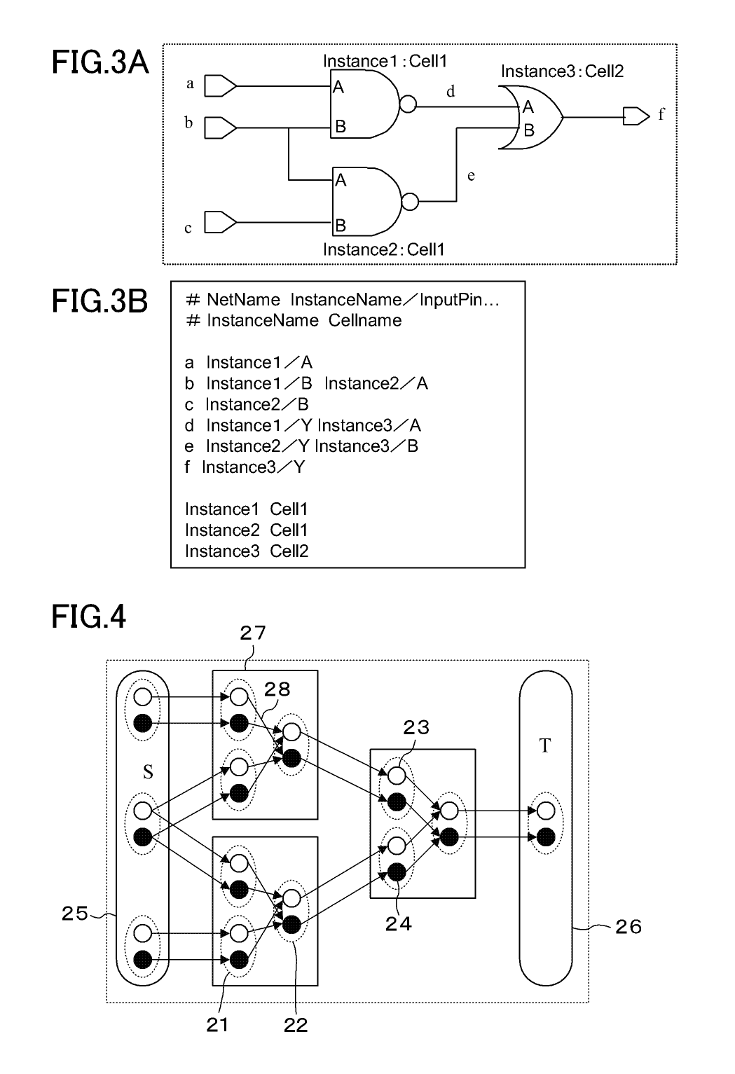

FIGS. 3A and 3B show an example of the circuit information 100 about a circuit to be designed. FIG. 3A is a circuit diagram, and FIG. 3B is a netlist representing the circuit of FIG. 3A.

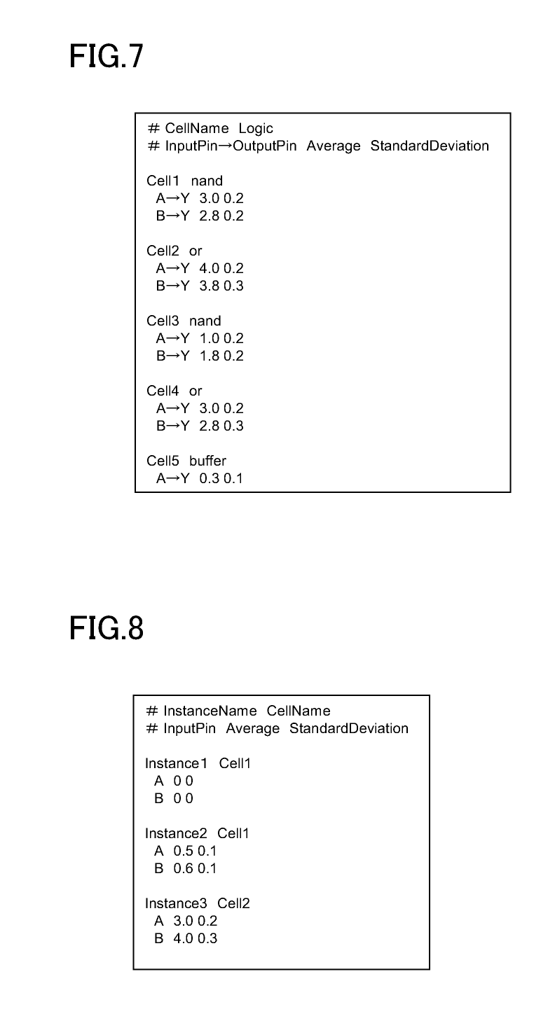

The technology information 200 of FIG. 1 contains information about device characteristics, such as a delay, a current, etc., based on a process to be designed. FIG. 7 shows an example of the technology information 200, indicating delay characteristics of logic cells included in a semiconductor integrated circuit. In FIG. 7, a cell 1 has NAND logic, and the average and standard deviation of delays from an input terminal A to an output terminal Y are 3.0 and 0.2, respectively, and the average and standard deviation of delays from an input terminal B to the output terminal Y are 2.8 and 0.2, respectively. A cell 3 is similar to the cell 1. A cell 2 has OR logic, the average and standard deviation of delays from an input terminal A to an output terminal Y are 4.0 and 0.2, respectively, and the average and standard deviation of delays from an input terminal B to the output terminal Y are 3.8 and 0.3, respectively. A cell 4 is similar to the cell 2. A cell 5 has buffer logic, and the average and standard deviation of delays from an input terminal A to an output terminal Y are 0.3 and 0.1, respectively.

Delay Distribution Calculation (ST100)

In the delay distribution calculation process ST100 of FIG. 1, the circuit information 100 and the technology information 200 are input, and paths are analyzed based on a connection relationship described in the circuit information 100, and the target circuit is analyzed based on delay information described in the technology information 200, and the results of the analysis are output as the delay distribution information 300 and the delay correlation information 400. The delay distribution calculation process ST100 may, for example, be performed by the technique described in Japanese Patent Publication No. 2002-279012.

FIG. 8 shows an example of the delay distribution information 300. The example of FIG. 8 shows

the average and standard deviation of delays at an input terminal A of an instance 1 are 0 and 0, respectively,

the average and standard deviation of delays at an input terminal B of the instance 1 are 0 and 0, respectively,

the average and standard deviation of delays at an input terminal A of an instance 2 are 0.5 and 0.1, respectively,

the average and standard deviation of delays at an input terminal B of the instance 2 are 0.6 and 0.1, respectively,

the average and standard deviation of delays at an input terminal A of an instance 3 are 3.0 and 0.2, respectively, and

the average and standard deviation of delays at an input terminal B of the instance 3 are 4.0 and 0.3, respectively.

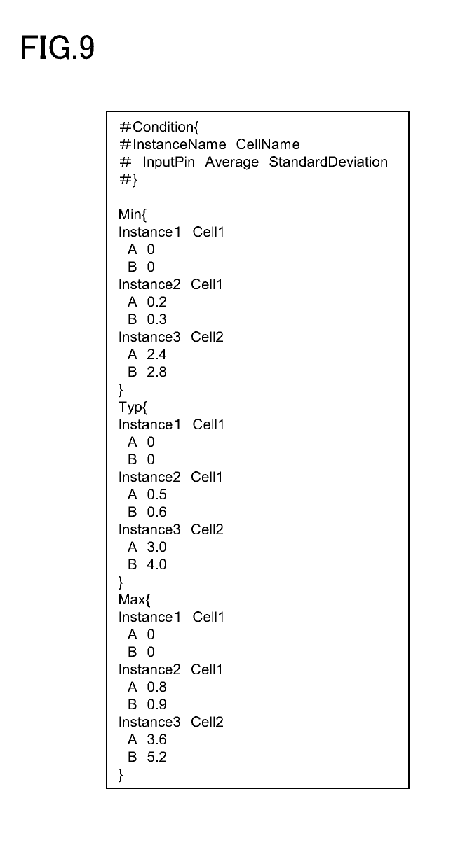

FIG. 9 shows another form of the delay distribution information 300. The example of FIG. 9 shows that the minimum value (Min) of delays is

0 at the input terminal A of the instance 1,

0 at the input terminal B of the instance 1,

0.2 at the input terminal A of the instance 2,

0.3 at the input terminal B of the instance 2,

2.4 at the input terminal A of the instance 3, and

2.8 at the input terminal B of the instance 3,

a representative value (Typ) of the delays is

0 at the input terminal A of the instance 1,

0 at the input terminal B of the instance 1,

0.5 at the input terminal A of the instance 2,

0.6 at the input terminal B of the instance 2,

3.0 at the input terminal A of the instance 3, and

4.0 at the input terminal B of the instance 3, and

the maximum value (Max) of the delays is

0 at the input terminal A of the instance 1,

0 at the input terminal B of the instance 1,

0.8 at the input terminal A of the instance 2,

0.9 at the input terminal B of the instance 2,

3.6 at the input terminal A of the instance 3, and

5.2 at the input terminal B of the instance 3.

In the delay calculation, typically, the maximum value (Max) and minimum value (Min) of delays are assumed to μ+3σ and μ−3σ, respectively, where μ is the average value of the delays and σ is the standard deviation of the delays. Alternatively, a different definition may be used. The typical value (Typ) may be an average value, a target value of a process, or a value having a highest probability.

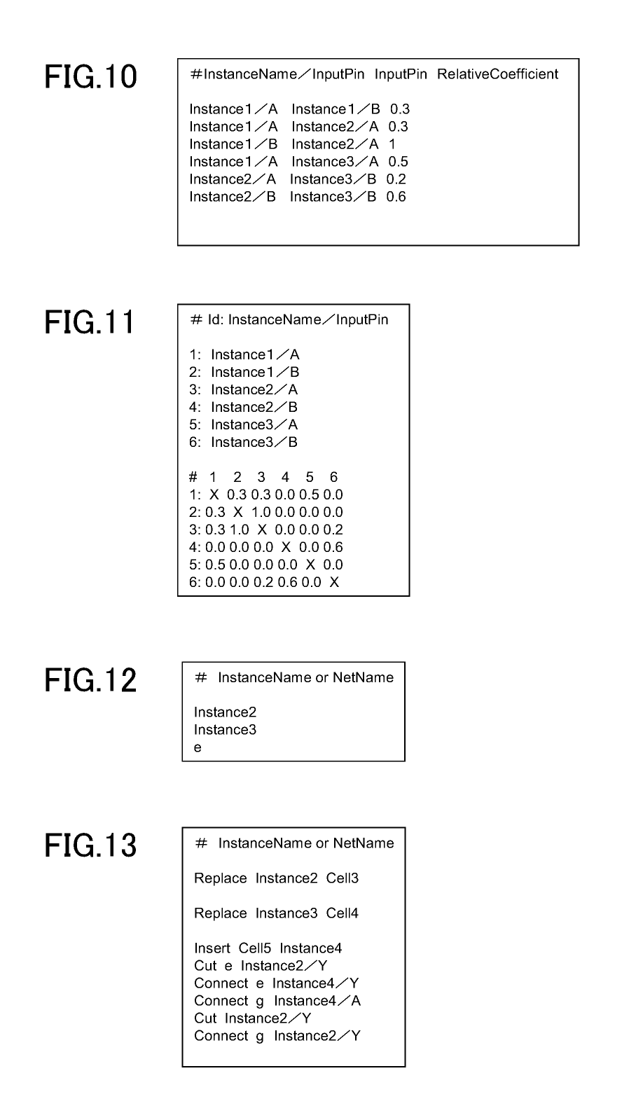

FIG. 10 shows an example of the delay correlation information 400. The example of FIG. 10 shows

a correlation coefficient (relative coefficient) between delays at the input terminal A of the instance 1 and delays at the input terminal B of the instance 1 is 0.3,

a correlation coefficient between delays at the input terminal A of the instance 1 and delays at the input terminal A of the instance 2 is 0.3,

a correlation coefficient between delays at the input terminal B of the instance 1 and delays at the input terminal A of the instance 2 is 1,

a correlation coefficient between delays at the input terminal A of the instance 1 and delays at the input terminal A of the instance 3 is 0.5,

a correlation coefficient between delays at the input terminal A of the instance 2 and delays at the input terminal B of the instance 3 is 0.2, and

a correlation coefficient between delays at the input terminal B of the instance 2 and delays at the input terminal B of the instance 3 is 0.6.

Correlation coefficients for the other combinations are zero, or correlation relationships of the other combinations are negligible.

FIG. 11 shows another form of the delay correlation information 400. The example of FIG. 11 shows

a correlation coefficient between delays at the input terminal A of the instance 1 and delays at the input terminal B of the instance 1 is 0.3,

a correlation coefficient between delays at the input terminal A of the instance 1 and delays at the input terminal A of the instance 2 is 0.3,

a correlation coefficient between delays at the input terminal A of the instance 1 and delays at the input terminal B of the instance 2 is 0,

a correlation coefficient between delays at the input terminal A of the instance 1 and delays at the input terminal A of the instance 3 is 0.5,

a correlation coefficient between delays at the input terminal A of the instance 1 and delays at the input terminal B of the instance 3 is 0,

a correlation coefficient between delays at the input terminal B of the instance 1 and delays at the input terminal A of the instance 2 is 1,

a correlation coefficient between delays at the input terminal B of the instance 1 and delays at the input terminal B of the instance 2 is 0,

a correlation coefficient between delays at the input terminal B of the instance 1 and delays at the input terminal A of the instance 3 is 0,

a correlation coefficient between delays at the input terminal B of the instance 1 and delays at the input terminal B of the instance 3 is 0,

a correlation coefficient between delays at the input terminal A of the instance 2 and delays at the input terminal B of the instance 2 is 0,

a correlation coefficient between delays at the input terminal A of the instance 2 and delays at the input terminal A of the instance 3 is 0,

a correlation coefficient between delays at the input terminal A of the instance 2 and delays at the input terminal B of the instance 3 is 0.2,

a correlation coefficient between delays at the input terminal B of the instance 2 and delays at the input terminal A of the instance 3 is 0,

a correlation coefficient between delays at the input terminal B of the instance 2 and delays at the input terminal B of the instance 3 is 0.6, and

a correlation coefficient between delays at the input terminal A of the instance 3 and delays at the input terminal B of the instance 3 is 0.

Similar to the information items of FIGS. 8 and 9, the information items of FIG. 10 are equivalent to those of FIG. 11.

Extraction of Circuit Modification Candidate (ST200)

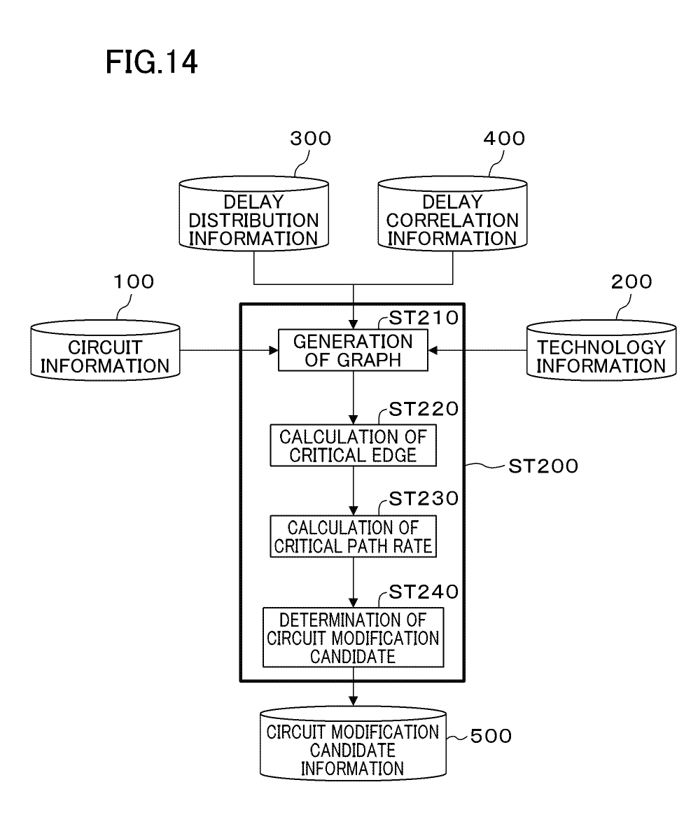

FIG. 14 shows a flow of a procedure performed in the circuit modification candidate extraction process ST200 of FIG. 1.

Generation of Graph (ST210)

In the graph generation process ST210, a graph is generated from the read circuit information 100 and is stored into the computer or a recording medium.

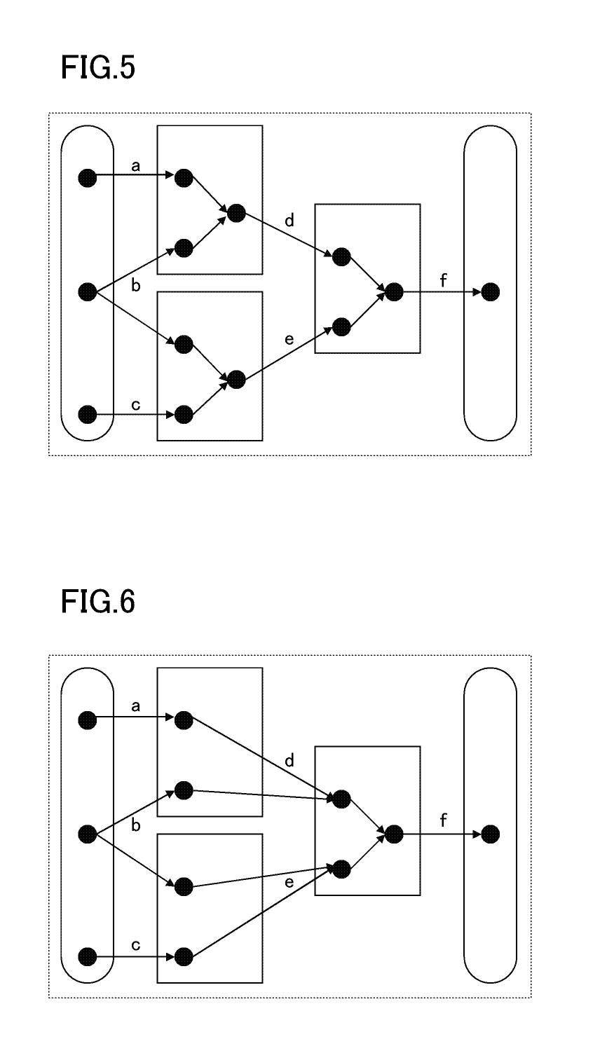

FIGS. 4-6 show example acyclic graphs representing the logic circuit of FIGS. 3A and 3B. In FIG. 5, for the sake of simplicity, a rising path and a falling path are represented by a common edge e and vertices v. In FIG. 6, an edge representing a cell delay and an edge representing an interconnect delay are represented by a single edge.

In an acyclic graph G={V, E}, a delay at an edge e (eεE) is represented by t(e). The delay t(e) is described in the technology information 200.

A delay at any vertex in a circuit is represented by x, the average and variance of a distribution of x are represented by μ and σ², respectively, and delays at two edges e₁ and e₂ (e₁, e₂εE) are represented by x₁=t(e₁) and x₂=t(e₂), respectively. In this case, a correlation coefficient ρ(x₁, x₂) between any two edges x₁ and x₂ is calculated by the delay distribution calculation process ST100.

A source vₛ may be an output terminal of a flip-flop, or a clock. A maximum value of delays from the source vₛ to any vertex v (vεV) is referred to as a delay at the vertex v and is represented by d(v). The maximum value d(v) is also calculated by the technique described in Japanese Patent Publication No. 2002-279012 etc., and is represented as the delay distribution information 300. Also, d(e)=d(u)+t(e) for an edge e=(u, v) (eεE) from a vertex u to a vertex v is referred to as a delay at the end vertex of the edge e. The probability density functions of the delays d(v) and d(e) are represented by φᵥ(x) and φₑ(x), respectively. It is known that φᵥ(x) and φₑ(x) can typically be approximated by normal distributions represented by:

$$\begin{matrix}{ϕ}_{v} ( x ) = \frac{1}{\sqrt{2 π} {σ}_{v}} exp [ - \frac{{( x - {μ}_{v} )}^{2}}{2 \cdot {( {σ}_{v} )}^{2}} ] & ( 1 ) \\ {ϕ}_{e} ( x ) = \frac{1}{\sqrt{2 π} {σ}_{e}} exp [ - \frac{{( x - {μ}_{e} )}^{2}}{2 \cdot {( {σ}_{e} )}^{2}} ] & ( 2 )\end{matrix}$$

where μᵥ and σᵥ² are the average and variance of d(vᵢ), respectively, and μₑ and σₑ² are the average and variance of d(e), respectively.

Calculation of Critical Edge (ST220)

Next, in a critical edge calculation process ST220, the probability that each signal is critical at a vertex (e.g., a multi-input cell etc.) where a plurality of signals merge together is calculated.

(Conditional Probability Density Function)

The probability that a condition cond is satisfied when d(v)=x is represented by P_{v[cond]}(x). The normal distribution probability density function of a delay d(v) at a vertex v is represented by φᵥ(x). The product of the probability density φᵥ(x) when d(v)=x and the probability P_{v[cond]}(x) that the condition cond is satisfied when d(v)=x, is referred to as a conditional probability density function of x under cond, and is represented by φ_{v[cond]}(x). In this case, the following is satisfied by definition:

φ_{v[cond]}(x)=φᵥ(x)·P_{v[cond]}(x) (3)

Therefore, when the probability density function φᵥ(x) of d(v)=x, and the conditional probability density function φ_{v[cond]}(x) of d(v)=x under cond, are known, the probability P_{v[cond]}(x) that the condition cond is satisfied when d(v)=x can be calculated by:

$${P}_{v [ cond ]} ( x ) = \frac{{φ}_{v [ cond ]} ( x )}{{ϕ}_{v} ( x )} \qquad ( 4 )$$

The probability P_{[cond]} that the condition cond is satisfied is obtained by integrating, over the entire region, the product of the probability P_{v[cond]}(x) that cond is satisfied when d(v)=x and the probability density φᵥ(x) of d(v)=x, and therefore, a relationship represented by Expression 5 is established. On the other hand, when a typical probability density function is integrated over the entire region, the resultant value is 1.

$$\begin{matrix}{P}_{[ cond ]} = {\int }_{- ∞}^{∞} {ϕ}_{v} ( x ) \cdot {P}_{v [ cond ]} ( x ) d x \\ = {\int }_{- ∞}^{∞} {φ}_{v [ cond ]} ( x ) d x\end{matrix} \qquad ( 5 )$$

Here, a negation of the condition cond is represented by /cond. The sum of the probability P_{v[cond]}(x) that cond is satisfied when d(v)=x and the probability P_{v[/cond]}(x) that cond is not satisfied when d(v)=x is 1. This is represented by:

P_{v[cond]}(x)+P_{v[/cond]}(x)=1 (6)

The following expressions are satisfied using Expression 6:

$$\begin{matrix}\begin{matrix}{φ}_{v [ cond ]} ( x ) + {φ}_{v [ / cond ]} ( x ) = {ϕ}_{v} ( x ) {P}_{v [ cond ]} ( x ) + {ϕ}_{v} ( x ) {P}_{v [ / cond ]} ( x ) \\ = {ϕ}_{v} ( x ) ( {P}_{v [ cond ]} ( x ) + {P}_{v [ / cond ]} ( x ) \\ = {ϕ}_{v} ( x )\end{matrix} & ( 7 ) \\ \begin{matrix}{P}_{v [ cond ]} + {P}_{v [ / cond ]} = {\int }_{- ∞}^{∞} {φ}_{v [ cond ]} ( x ) d x + {\int }_{- ∞}^{∞} {φ}_{v [ / cond ]} ( x ) d x \\ = {\int }_{- ∞}^{∞} ( {φ}_{v [ cond ]} ( x ) + {φ}_{v [ / cond ]} ( x ) ) d x \\ = {\int }_{- ∞}^{∞} {ϕ}_{v} ( x ) d x \\ = 1\end{matrix} & ( 8 )\end{matrix}$$

Here, the condition that x>c (c is a constant) will be described. In this case, the probability P_{v[x>c]}(x) that the condition x>c is satisfied when d(v)=x is represented by:

P_{v[x>c]}(x)=u(x−c) (9)

where u(x) is a step function of x.

Therefore, the conditional probability density function φ_{v[x>c]}(x) of d(v)=x under x>c is represented by:

φ_{v[x>c]}(x)=φᵥ(x)·u(x−c) (10)

The probability P_{v[/(x>c)]}(x) that x>c is not satisfied when d(v)=x is represented by:

P_{v[/(x>c)]}(x)=1−u(x−c) (11)

Therefore, the following expressions are established:

$$\begin{matrix}\begin{matrix}{P}_{v [ x > c ]} ( x ) + {P}_{v [ / ( x > c ) ]} ( x ) = u ( x - c ) + 1 - u ( x - c ) \\ = 1\end{matrix} & ( 12 ) \\ \begin{matrix}{φ}_{v [ x > c ]} ( x ) + {φ}_{v [ / ( x > c ) ]} ( x ) = {ϕ}_{v} ( x ) \cdot u ( x - c ) + {ϕ}_{v} ( x ) \cdot [ 1 - u ( x - c ) ] \\ = {ϕ}_{v} ( x ) \cdot [ u ( x - c ) + 1 - u ( x - c ) ] \\ = {ϕ}_{v} ( x )\end{matrix} & ( 13 ) \\ \begin{matrix}{P}_{v [ x > c ]} + {P}_{v [ / ( x > c ) ]} = {\int }_{- ∞}^{∞} {ϕ}_{v} ( x ) \cdot u ( x - c ) d x + \\ {\int }_{- ∞}^{∞} {ϕ}_{v} ( x ) \cdot [ 1 - u ( x - c ) ] d x \\ = {\int }_{- ∞}^{∞} {ϕ}_{v} ( x ) \cdot [ u ( x - c ) + 1 - u ( x - c ) ] d x \\ = {\int }_{- ∞}^{∞} {ϕ}_{v} ( x ) d x \\ = 1\end{matrix} & ( 14 )\end{matrix}$$

Here, it is assumed that there are two independent conditions cond1 and cond2. The probability P_{v[cond1 & cond2]}(x) that cond1 and cond2 are satisfied is represented by the product of P_{v[cond1]}(x) and P_{v[cond2]}(x):

P_{v[cond1&cond2]}(x)=P_{v[cond1]}(x)·P_{v[cond 2]}(x) (15)

The conditional probability density function φ_{v[cond1 & cond2]}(x) of x under cond1 and cond2 is represented by:

$$\begin{matrix}{ϕ}_{v [ cond 1 \& cond 2 ]} ( x ) = {ϕ}_{v} ( x ) \cdot {P}_{v [ cond 1 \& cond 2 ]} ( x ) \\ = {ϕ}_{v} ( x ) \cdot {P}_{v [ cond 1 ]} ( x ) \cdot {P}_{v [ cond 2 ]} ( x ) \\ = {φ}_{v [ cond 1 ]} ( x ) \cdot {P}_{v [ cond 2 ]} ( x ) \\ = {φ}_{v [ cond 2 ]} ( x ) \cdot {P}_{v [ cond 1 ]} ( x )\end{matrix} \qquad ( 16 )$$

Calculation of Critical Edge (ST220)

For a given vertex v, a set of edges entering v is represented by eᵥ={e₁, . . . , eₖ, . . . , eₙ}. An edge having the largest of delays d(e₁), . . . , and d(eₙ) at the end vertices of the edges entering the vertex v is referred to as a critical edge. In other words, an edge eₖ=(u, v) entering the vertex v is a critical edge when the delay d(eₖ) at the end vertex of eₖ is larger than the delays d(e′) of the other edges e′=(u′, v) entering v. In this case, a delay at the end vertex of the critical edge is equal to a delay at the vertex v.

Now, the condition that an edge eₖ entering the vertex v is a critical edge is represented by eₖεE_{ce}. When a delay at an edge eₖ is xₖ=d(eₖ), the probability P_{[ekεEce]}(xₖ) that the edge eₖ is a critical edge can be considered to be the probability that all delays xⱼ=d(eⱼ) at the edges eⱼ (j=1, . . . , and n, j≠k) where x={x₁, . . . , xₙ}={d(e₁), . . . , d(eₙ)} are smaller than or equal to xₖ. Therefore, the probability P_{[ekεEce]}(xₖ) can be represented by:

P_{┌c}_{ₖ}_{εE}_{_{ce}}_{┐}=∫_{-∞}^{∞}∫_{-∞}^{x}^{ₖ} . . . ∫_{-∞}^{x}^{ₖ}∫_{-∞}^{x}^{ₖ} . . . ∫_{-∞}^{x}^{ₖ}φₙ(x)dx₁ . . . dxₖ₋₁dxₖ₊₁ . . . dxₙdxₖ (17)

where φₙ(x) is a probability density function relating to an n-variate x={x₁, . . . , xₙ}, which is known to be able to be generally approximated by a normal distribution function.

When n=1, when a delay at the edge e₁ is x₁=d(e₁), the probability P_{[e1εEce]}(x₁) that the edge e₁ is a critical edge is represented by Expression 18. In other words, the edge e₁ entering the vertex v is a critical edge.

P_{[e}_{ₖ}_{εE}_{_{ce}}_{]}=∫_{-∞}^{∞}φₙ(x)dxₖ=∫_{-∞}^{∞}φ₁(x₁)dx₁=1 (18)

The conditional probability density function φ_{ek[ekεEce]}(xₖ) of xₖ=d(eₖ) under eₖεE_{ce} is represented by Expression 19, similar to Expression 17.

φₑ_{_{k┌e}}_{ₖ}_{εE}_{_{ce}}_{┐}(xₖ)=∫_{-∞}^{x}^{ₖ} . . . ∫_{-∞}^{x}^{ₖ}∫_{-∞}^{x}^{ₖ} . . . ∫_{-∞}^{x}^{ₖ}φₙ(x₁, . . . , xₙ)dx₁ . . . dxₖ₋₁dxₖ₊₁ . . . dxₙdxₖ (19)

Here, the n-variate normal distribution function φₙ(x) is represented by:

$${ϕ}_{n} ( x ) = \frac{1}{{\sqrt{2 π}}^{N}} \sqrt{\vert {σ}^{ij} \vert} exp [ - \frac{{( x - μ )}^{T} {σ}^{ij} ( x - μ )}{2} ] \qquad ( 20 )$$

where (x−μ)^{T}=(x₁−μ₁ x₂−μ₂ . . . x_{N}−μ_{N}) is the transposed matrix of (x−μ), and σ^{ij} is the inverse matrix of σᵢⱼ (σ^{ij}=(σᵢⱼ)⁻¹). The matrix σᵢⱼ is defined by:

$${σ}_{ij} = ( \begin{matrix}{σ}_{1}^{2} & {σ}_{1} {σ}_{2} {ρ}_{12} & … & {σ}_{1} {σ}_{n} {ρ}_{1 n} \\ {σ}_{1} {σ}_{2} {ρ}_{12} & {σ}_{2}^{2} & … & {σ}_{2} {σ}_{n} {ρ}_{2 n} \\ ⋮ & ⋮ & ⋱ & ⋮ \\ {σ}_{1} {σ}_{n} {ρ}_{1 n} & {σ}_{2} {σ}_{n} {ρ}_{2 n} & … & {σ}_{n}^{2}\end{matrix} ) \qquad ( 21 )$$

Note that when n=1, the conditional probability density function φ_{e1[e1εEce]}(x₁) of x₁=d(e₁) under e₁εE_{ce} is represented by:

φₑ_{₁}_{[e}_{₁}_{εE}_{_{ce}}_{]}(x₁)=φₙ(x)=φ₁(x₁) (22)

where φ₁(x₁) is the probability density function of x₁=d(e₁).

The calculation of Expression 19 includes integration, but can be simply performed using approximation represented by:

$$\begin{matrix}{\int }_{- ∞}^{∞} ϕ ( x ) d x ≅ {\int }_{a}^{b} ϕ ( x ) d x \\ ≅ {\sum }_{i = 1}^{F} d \cdot ϕ ( a + d \cdot i )\end{matrix} \qquad ( 23 )$$

where F (F is a natural number) is the number of partitions in the integration calculation, a and b (a<b) are the lower and upper limits of the approximation calculation region, respectively, and d (>0) is the width of each partition in the integration calculation and is defined by Expression 24. When a→−∞ and b, F→−∞, the approximation error is zero.

d=(b−a)/F (24)

For all edges eₖ contained in the graph G, the conditional probability density function φ_{ek[ekεEce]}(xₖ) that the edge eₖ is a critical edge can be obtained by the following algorithm 1.

[Algorithm 1]

(1) The probability density functions φᵥ(x) of delays at all vertices v (vεV) and the probability density functions φₑ(x) of delays at the end vertices of all edges e (eεE) in the acyclic graph G={V, E} are calculated by the technique of Japanese Patent Publication No. 2002-279012.

(2) A vertex v (vεV) is selected from the graph.

(3) For each of edges eₖ entering the selected vertex v, the conditional probability density function φ_{ek[ekεEce]}(xₖ) of a delay at the end vertex of the edge eₖ under the condition that the edge eₖ is a critical edge is calculated using Expression 19.

(4) (2) and (3) are applied to all the vertices.

According to Expressions 20 and 21, the complexity of calculation of the n-variate probability density function φₙ(x₁, . . . , xₙ) is O(n²). Therefore, according to Expressions 19 and 23, the complexity of calculation of φ_{ek[ekεEce]}(xₖ) is O(n³×F). The complexity of calculation of the conditional probability density function φ_{ek[ekεEce]}(xₖ) of xₖ under the condition that an edge eₖ is a critical edge for all edges eₖ contained in the graph G is represented by

$$O ( F \times {\sum }_{k = 1}^{N} {n ( {e}_{k} )}^{3} ) \qquad ( 25 )$$

where N is the total number of edges contained in the graph G, i.e., a circuit size, and n(eₖ) is the number of edges entering the end vertex of an edge eₖ. Note that when the circuit size is large, i.e., N>>n(eₖ) and N>>F, the complexity of calculation of φ_{ek[ekεEce]}(xₖ) is O(N). Therefore, the calculation can be completed within a practical period of time.

Calculation of Critical Path Rate (ST230)

Next, in a critical path rate calculation process ST230, the probability that a vertex or edge in a graph is on a critical path is calculated. Note that a vertex or edge on a critical path corresponds to a device or interconnect on a critical path in a circuit to be designed.

(Definition of Critical Path)

In an acyclic graph G={V, E}, a path whose start vertex is a vertex vₛ corresponding to a source and whose end vertex is a vertex vₜ corresponding to a sink is referred to as a path p, which is represented by p={Eₚ, Vₚ}, where Eₚ={eₚ₁, . . . , eₚⱼ, . . . , eₚₘ} is a set of edges on the path p, Vₚ={vₚ₀, . . . , vₚⱼ, . . . , vₚₘ} is a set of vertices on the path p, vₚ₀ is a vertex corresponding to the sink vₜ, and vₚₘ is a vertex corresponding to the source vₛ. The edges are sequentially sorted from the sink to the source. Specifically, the start vertex and end vertex of an edge eₚⱼ correspond to vₚⱼ and vₚ₍ⱼ₋₁₎, respectively. A set of all paths in the graph G is represented by p={p₁, . . . , pⱼ, . . . , pₙ}, and the total sum of delays t(e) at all edges e on each path pⱼ is referred to as a path delay of pⱼ and is represented by t(pⱼ). A path having the largest path delay t(pⱼ) is referred to as a critical path. The condition that a vertex v is on a critical path and the condition that an edge e is on a critical path are represented by vεV_{cp} and eεE_{cp}, respectively.

Here, an edge e=(u, v) is said to be included in a critical path (eεE_{cp}) if both the start vertex u and end vertex v of the edge e are included in the critical path (u, vεV_{cp}) and the edge e is a critical edge (eεE_{ce}). On the other hand, a vertex v is said to be included in a critical path (vεV_{cp}) if at least one of edges eᵢ=(u, v) entering the vertex v is included in the critical path and at least one of edges eₒ=(v, w) leaving the vertex v is included in the critical path.

In this case, for a given vertex v, a set of edges leaving the vertex v is represented by eₒ={eₒ₁, . . . , eₒⱼ, . . . , eₒₘ}, and a set of edges entering the vertex v is represented by eᵢ={eᵢ₁, . . . , eᵢₖ, . . . , eᵢₙ}. The total sum of the probabilities P_{[eojεEcp]} that an edge eₒⱼ leaving the vertex v is on a critical path is represented by:

$${\sum }_{j = 1}^{l} {P}_{[ {e}_{oj} ∈ {E}_{cp} ] } \qquad ( 26 )$$

The total sum of the probabilities P_{[eikεEcp]} that an edge eᵢₖ entering the vertex v is on a critical path is represented by:

$${\sum }_{k = 1}^{n} {P}_{[ {e}_{ik} ∈ {E}_{cp} ] } \qquad ( 27 )$$

Both the total sum of the probabilities P_{[eojεEcp]} and the total sum of the probabilities P_{[eikεEcp]} is equal to the probability P_{[vεVcp]} that the vertex v is on a critical path. The probability P_{[vεVcp]} is represented by:

$${P}_{[ v ∈ {V}_{cp} ] } = {\sum }_{j = 1}^{l} {P}_{[ {e}_{oj} ∈ {E}_{cp} ] } = {\sum }_{k = 1}^{n} {P}_{[ {e}_{ik} ∈ {E}_{cp} ] } \qquad ( 28 )$$

The conditional probability density function of a delay d(v) at the vertex v under the condition that the vertex v (vεV) is on a critical path is represented by φ_{v[vεVcp]}(x). The conditional probability density function of a delay at the vertex v under the condition that an edge eₒⱼ leaving the vertex v is on a critical path is represented by φ_{v[eojεEcp]}(x). The conditional probability density function φ_{v[vεVcp]}(x) of d(v)=x under the condition that the vertex v is on a critical path is equal to the total sum of the conditional probability densities φ_{v[eojεEcp]}(x) of edges eₒⱼ leaving the vertex v under the condition that the edge eₒⱼ is on a critical path, which is represented by:

$${\sum }_{j = 1}^{l} {φ}_{v [ {e}_{oj} ∈ {E}_{cp} ]} ( x ) \qquad ( 29 )$$

and is also equal to the total sum of the conditional probability densities φ_{v[eojεEcp]}(x) of edges eᵢₖ entering the vertex v under the condition that the edge eᵢₖ is on a critical path, which is represented by:

$$\begin{matrix}{\sum }_{k = 1}^{n} {φ}_{v [ {e}_{ik} ∈ {E}_{cp} ]} ( x ) \\ i . e . , & ( 30 ) \\ {φ}_{v [ v ∈ {V}_{cp} ]} ( x ) = {\sum }_{k = 1}^{n} {φ}_{v [ {e}_{ik} ∈ {E}_{cp} ]} ( x ) \\ {φ}_{v [ v ∈ {V}_{cp} ]} ( x ) = {\sum }_{j = 1}^{l} {φ}_{v [ {e}_{oj} ∈ {E}_{cp} ]} ( x ) & ( 31 )\end{matrix}$$

(Calculation of Distribution of Conditional Probability Density)

The probability that a vertex v is on a critical path when a delay d(v) at the vertex v is x is represented by P_{v[vεVcp]}(x), and the probability that an edge e is a critical edge when d(v)=x is represented by P_{v[eεEce]}(x). Now, while it is determined whether or not an edge e entering a vertex v is a critical edge, based on a path from a source vₛ to the vertex v, it is determined whether or not a vertex v is on a critical path, based on all paths from a source vₛ to a sink vₜ. Therefore, for a vertex v close to a source vₛ (i.e., the smallest of the numbers of edges included in paths from vₛ to v is smaller than the smallest of the numbers of edges included in paths from vₛ to vₜ), it can be considered that “vεV_{cp} when d(v)=x” and “eεE_{ce} when d(v)=x” are substantially independent from each other.

Therefore, according to Expression 15, the probability P_{v[eεEce]}(x) that an edge e is on a critical path when a delay at the end vertex v of the edge e is d(v)=x is equal to the probability that vεV_{cp} and eεE_{ce}, and therefore, is represented by:

P_{v[eεE}_{_{cp}}_{]}(x)=P_{v[vεV}_{_{cp}}_{]}(x)·P_{v[eεE}_{_{ce}}_{]}(x) (32)

When eεE_{cp} or eεE_{ce}, a delay d(e) at the end vertex of the edge e is equal to the delay d(v) at the vertex v. Therefore, under the condition that eεE_{cp} or eεE_{ce}, Expression 33 is established:

P_{v[eεE}_{_{cp}}_{]}(x)=P_{e[eεE}_{_{cp}}_{]}(x)

P_{v[eεE}_{_{ce}}_{]}(x)=P_{e[eεE}_{_{ce}}_{]}(x) (33)

where P_{e[vεVce]}(x) is the probability that the vertex v is on a critical path when the delay d(e) at the end vertex of the edge e is x, and P_{e[eεEce]}(x) is the probability that the edge e is a critical edge when the delay d(e) at the end vertex of the edge e is x.

Therefore, Expression 32 is rewritten as:

P_{e[eεE}_{_{cp}}_{]}(x)=P_{v[vεV}_{_{cp}}_{]}(x)·P_{e[eεE}_{_{ce}}_{]}(x) (34)

Here, z=x+y is established, where x is a delay d(u) at the start vertex u of the edge e, z is the delay d(v) at the end vertex v of the edge e, and y is a delay t(e) at the edge e. Therefore, according to Expression 3, the conditional probability density function φ_{u, t(e)[eεEcp]}(x, y) of x and y under eεE_{cp} is represented by the product of the bivariate probability density function φ_{u, t(e)}(x, y) of x=d(u) and y=t(e) and the probability P_{e[eεEcp]}(z) (=P_{e[eεEcp]}(x+y)) that eεE_{cp} is established:

φ_{u,t(e)[eεE}_{_{cp}}_{]}(x,y)=φ_{u,t(e)}(x,y)·P_{e[eεE}_{_{cp}}_{]}(x+y) (35)

Here, P_{[eεEcp]}(x, y) is the probability that eεE_{cp} is established when a delay at the start vertex u of the edge e is x=d(u) and a delay at the edge e is y=t(e). Therefore, the conditional probability density function φ_{u[eεEcp]}(x) of x under eεE_{cp} is obtained by integrating φ_{u, t(e)[eεEcp]}(x, y) over a delay y at an edge eₖ:

$$\begin{matrix}{φ}_{u [ e ∈ {E}_{cp} ]} ( x ) = {\int }_{- ∞}^{∞} {φ}_{u , l ( e ) [ e ∈ {E}_{cp} ]} ( x , y ) d y \\ = {\int }_{- ∞}^{∞} {ϕ}_{u , l ( e )} ( x , y ) \cdot {P}_{e [ e ∈ {E}_{cp} ]} ( x + y ) d y \\ = {\int }_{- ∞}^{∞} {ϕ}_{u , t ( e )} ( x , y ) \cdot {P}_{v [ v ∈ {V}_{cp} ]} ( x + y ) \cdot \\ {P}_{e [ e ∈ {E}_{ce} ]} ( x + y ) d y\end{matrix} \qquad ( 36 )$$

Here, according to Expression 4, the following expression is obtained:

$${P}_{v [ v ∈ {V}_{cp} ]} ( x ) = \frac{{φ}_{v [ v ∈ {V}_{cp} ]} ( x )}{{ϕ}_{v} ( x )} \\ {P}_{e [ e ∈ {E}_{ce} ]} ( x ) = \frac{{φ}_{e [ e ∈ {E}_{ce} ]} ( x )}{{ϕ}_{e} ( x )} \qquad ( 37 )$$

Here, φ_{u, t(e)}(x, y), φₑ(x), and φᵥ(x) can be previously calculated by the technique of Japanese Patent Publication No. 2002-279012, and φ_{e[eεEce]}(x) can be previously calculated by Expression 19. Therefore, if the conditional probability density function φ_{v[vεVcp]}(x) of a vertex v under the condition that the vertex v is on a critical path is known, the conditional probability density function φ_{u[eεEcp]}(x) of a delay at the start vertex u of each edge eₖ entering the vertex v under the condition that the edge eₖ is on a critical path can be obtained.

(Calculation of Critical Path Rate for Each Edge)

A vertex vₜ (=vₚ₀) corresponding to a sink is included in all paths. Therefore, the conditional probability density function φ_{vt[vtεVcp]}(x) of vₜ under the condition that the sink vₜ is on a critical path is equal to the probability density function φᵥₜ(x) of vₜ (Expressions 38 and 39).

Pᵥ_{ₜ}_{[v}_{ₜ}_{εV}_{_{cp}}_{]}(x)=1 (38)

φᵥ_{ₜ}_{[v}_{ₜ}_{εV}_{_{cp}}_{]}(x)=φᵥ_{ₜ}(x) (39)

Therefore, in an acyclic graph G={V, E}, the conditional probability density function φ_{vt[vtεVcp]}(x) of a delay at any vertex v in the graph under the condition that the vertex v is on a critical path, and the conditional probability density function φ_{u[eεEcp]}(x) of a delay at the start vertex u of any edge e in the circuit under the condition the edge e is on a critical path, can be calculated by an algorithm 2 described below.

[Algorithm 2]

(1) For all edges e, the conditional probability density function φ_{e[eεEce]}(x) of the edge e under the condition that the edge e is a critical edge is calculated.

(2) A vertex vₜ corresponding to a sink is set to an initial value shown by Expression 39.

(3) Edges e are selected in a reverse topological order in the acyclic graph.

(4) The conditional probability density function φ_{u[eεEcp]}(x) of a delay at the start vertex u of a selected edge e under the condition that the edge e is on a critical path is calculated by Expressions 36 and 37.

(5) When φ_{u[eojεEcp]}(x) has been calculated for all edges eₒⱼ leaving the vertex u, the conditional probability density function φ_{u[uεVcp]}(x) of a delay at the vertex u under the condition that the vertex u is on a critical path is calculated based on Expression 31.

(6) The processes of (3)-(5) are repeated for all edges and vertices.

When there is a delay constraint D on a circuit to be designed, the probability that a path p is a critical path and the delay value of the path p is D or more may be calculated. Therefore, this probability can be calculated using Expression 40 as an initial value instead of Expression 39.

φᵥ_{ₜ}_{[v}_{ₜ}_{εV}_{_{cp}}_{]}(x)=(x−D)·φᵥ_{ₜ}(x) (40)

where u(x) is a step function.

The probability P_{[eεEcp]} that an edge e is on a critical path and the probability P_{[vεVcp]} that a vertex v is on a critical path can be obtained by integrating the conditional probability density function φ_{v[vεVcp]}(x) of the vertex v under the condition that the vertex v is on a critical path and the conditional probability density function φ_{u[eεEcp]}(x) of the edge e under the condition that the edge e is on a critical path:

P_{[vεV}_{_{cp}}_{]}=∫_{-∞}^{∞}φ_{v[vεV}_{_{cp}}_{]}(x)dx

P_{[eεE}_{_{cp}}_{]}=∫_{-∞}^{∞}φ_{u[eεE}_{_{cp}}_{]}(x)dx (41)

The complexity of calculation of the probability P_{[vεVcp]} that a vertex is on a critical path for all vertices included in the graph G, and the probability P_{[eεEcp]} that an edge is on a critical path for all edges in the graph G, is O(N) when N>>F, where N is a circuit size and F is the number of partitions in integration calculation. Therefore, it can be said that the calculation process of this method can be completed within a practical period of time.

Determination of Circuit Modification Candidate (ST240)

Next, in a circuit modification candidate determination process ST240, the circuit modification candidate information 500 for improving a delay is output. The circuit modification candidate information 500 may be an edge having a high critical path rate, or the product of a critical path rate and a coefficient indicating a sensitivity, such as a delay improvement rate etc., with respect to cost, such as an increase in area, power consumption, etc. caused by circuit modification. The number of candidates for improvement to be extracted may be predetermined, or only those whose critical path rate exceeds a predetermined probability may be extracted. If the delay constraint D is given, all edges for which the value of Expression 40 is positive may be extracted.

FIG. 12 shows an example of the circuit modification candidate information 500 which is extracted by the circuit modification candidate determination process ST240. FIG. 12 shows that an instance 2, an instance 3, and an interconnect e are candidates for circuit modification.

FIG. 13 shows another example form of the circuit modification candidate information 500. FIG. 13 shows a specific modification of the modification candidates of FIG. 12. In FIG. 13, the instance 2 as a modification candidate is replaced with a cell 3, the instance 3 is replaced with a cell 4, a cell 5 is inserted as an instance 4, a net e is cut off an output terminal Y of the instance 2 and is connected to an output terminal Y of the instance 4, and the output terminal Y of the instance 2 is connected to an input terminal A of the instance 4 by a net g.

Improvement of Circuit (ST300)

Finally, in the circuit improvement process ST300 of FIG. 1, the circuit information 100 is modified based on the circuit modification candidate information 500.

For example, when the circuit modification candidate information 500 of FIG. 12 is used, the instances 2 and 3 may be replaced with a cell having higher speed so that a delay on a path passing through the input terminal B is reduced. The interconnect e may be modified with a higher priority by, for example, causing another interconnect to take a different (longer) path, thereby reducing a delay on the interconnect e.

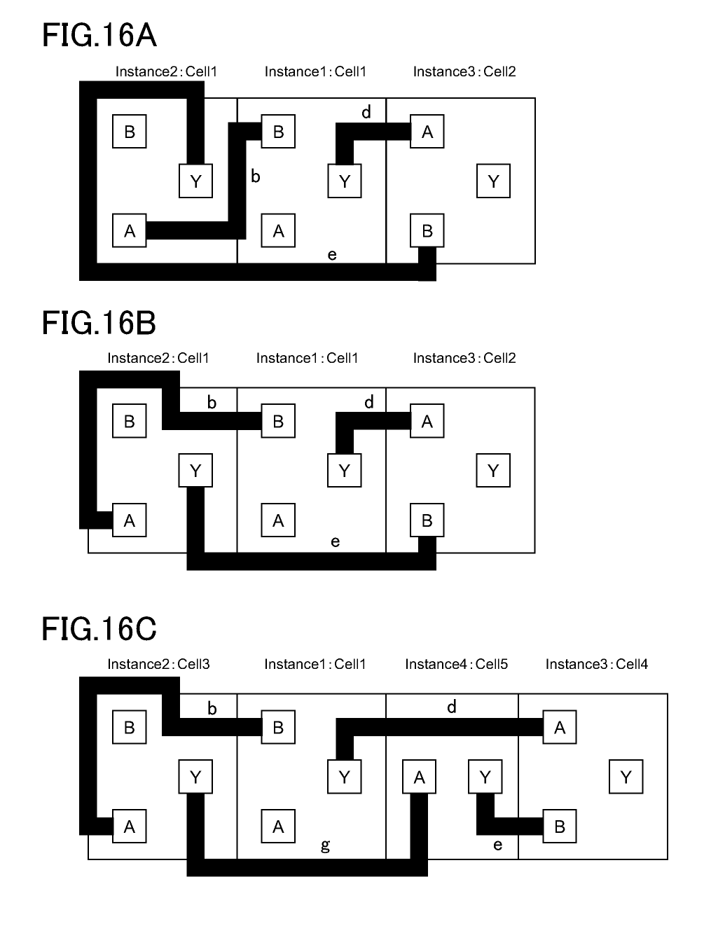

FIGS. 16A-16C show examples of the circuit information 100 of a circuit to be designed, where the circuit information 100 is layout information (the arranged circuit information 100b and interconnected circuit information 100c of FIG. 2).

FIG. 16A shows an example of the circuit information 100 before modification performed by the circuit improvement process ST300, which is layout information of the circuit information 100 of FIGS. 3A and 3B. The cell 1, the cell 1, and the cell 2 are provided in the instance 1, the instance 2, and the instance 3, respectively, the cells are interconnected by the nets b, d, and e.

FIG. 16B shows an example of the circuit information 100 after the circuit information 100 of FIG. 16A is modified by the circuit improvement process ST300 based on the circuit modification candidate information 500 of FIG. 12. FIG. 16B shows an example modification in a case where the net e is extracted as the circuit modification candidate information 500. By causing the interconnect of the net b to take a different (longer) path to design the net e having a higher critical path rate with a higher priority to reduce a delay, the delay improvement effect can be obtained using the same area.

When the circuit modification candidate information 500 of FIG. 13 is used, a delay can be reduced by replacing the cells 1 and 2 of the instances 2 and 3 with the cells 3 and 4 having higher performance, respectively, and inserting a buffer (cell 5) into the net e.

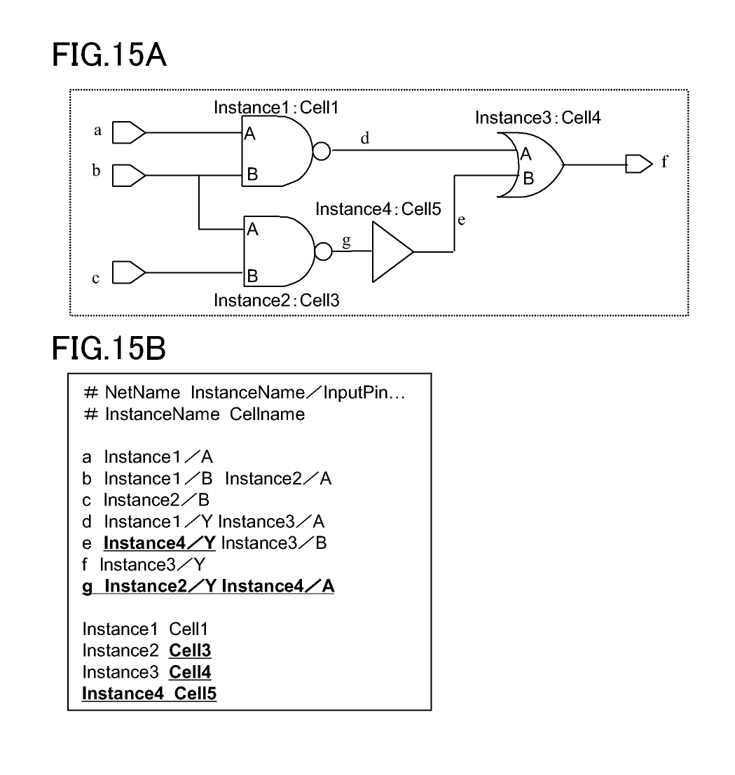

FIGS. 15A and 15B show an example of the circuit information 100 after the circuit information 100 of FIGS. 3A and 3B is modified by the circuit improvement process ST300 based on the circuit modification candidate information 500 of FIG. 13. In FIGS. 15A and 15B, a cell 5 is newly inserted as the instance 4, and the input terminal A of the instance 4 is connected to the output terminal Y of the instance 2. Also, the cells 1 and 2 of the instances 1 and 2 are replaced with the cells 3 and 4, respectively, and the destination of the input terminal B of the instance 3 is modified from the instance 2 to the instance 4.

FIG. 16C shows an example of the circuit information 100 after the circuit information 100 of FIG. 16A is modified by the circuit improvement process ST300 based on the circuit modification candidate information 500 of FIG. 13, which is a layout corresponding to the circuit information 100 of FIG. 15. A delay can be improved by replacing the cells of the instances 2 and 3 having a higher critical path rate with a cell having a smaller delay, causing the net b to take a different (longer) path to design the net e having a higher critical path rate with a higher priority, and inserting a buffer (cell 5) into the net e.

Thus, according to this embodiment, a delay in a circuit to be designed can be reduced by accurately examining a delay distribution and a delay correlation.

There are various variations of the above embodiment. Some variations will be described hereinafter.

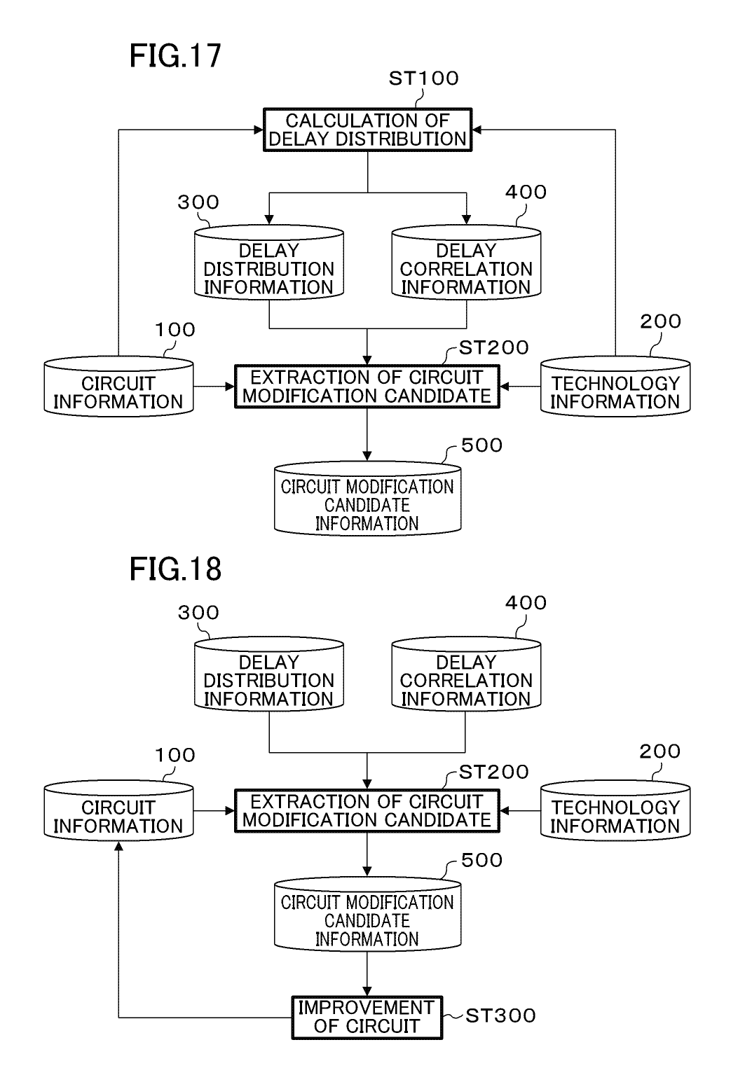

FIG. 17 shows a variation in which the circuit improvement process ST300 is removed from the process of the embodiment of FIG. 1. Even though the circuit improvement process ST300 is removed, it is advantageously possible to extract a portion of a circuit which should be modified in order to reduce a maximum delay or correct a delay constraint violation. By optionally modifying the circuit by employing a commercially available layout tool, or manually by a designer himself or herself, in combination with the circuit improvement, a design flow can be more flexibly selected.

FIG. 18 shows a variation in which the delay distribution calculation ST100 is removed from the process of the embodiment of FIG. 1. Even though the delay distribution calculation ST100 is removed, it is advantageously possible to extract a portion of a circuit which should be modified in order to reduce a maximum delay or correct a delay constraint violation. By optionally performing calculation by employing a commercially available layout tool, or manually by a designer himself or herself, in combination with the delay distribution calculation, a design flow can be more flexibly selected.

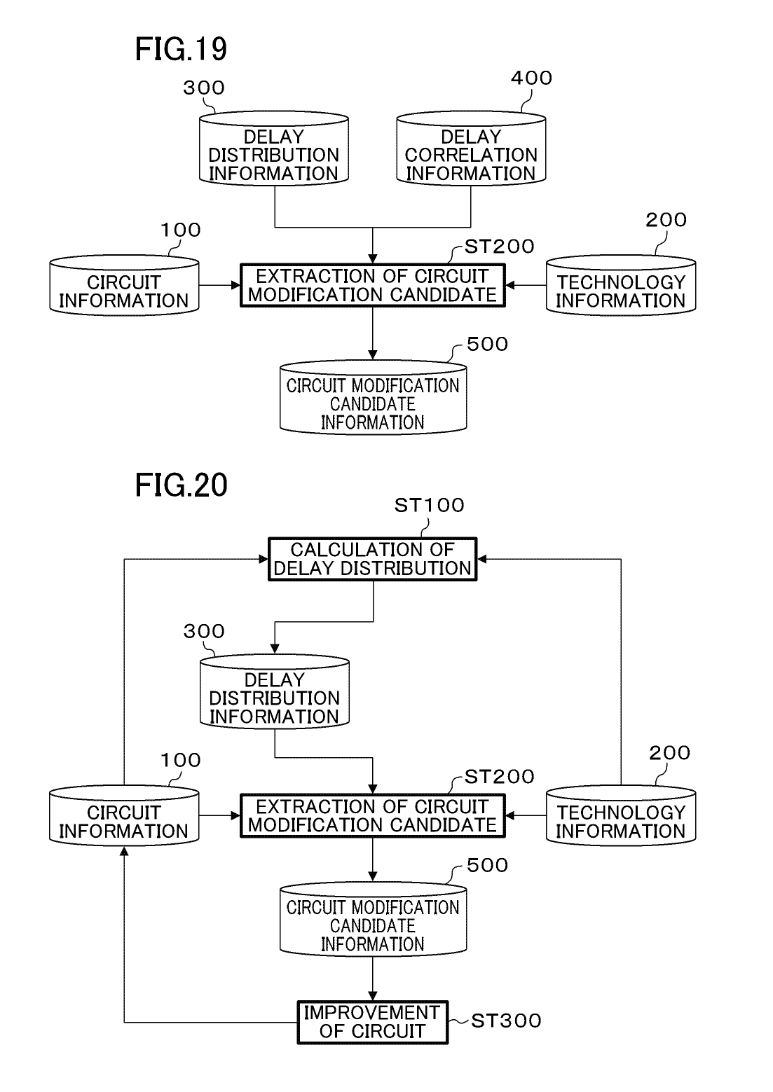

FIG. 19 shows a variation in which the circuit improvement process ST300 and the delay distribution calculation ST 100 are removed from the process of the embodiment of FIG. 1. Even though the circuit improvement process ST300 and the delay distribution calculation ST100 are removed, it is advantageously possible to extract a portion of a circuit which should be modified in order to reduce a maximum delay or correct a delay constraint violation. By optionally performing calculation or modifying the circuit by employing a commercially available layout tool, or manually by a designer himself or herself, in combination with the delay distribution calculation and the circuit improvement, a design flow can be more flexibly selected.

FIG. 20 shows a variation in which the delay correlation information 400 is removed from the process of the embodiment of FIG. 1. Even though the delay correlation information 400 is removed, it is advantageously possible to extract a portion of a circuit which should be modified in order to reduce a maximum delay or correct a delay constraint violation, although the accuracy is reduced in some circuits. For example, even if it is difficult to output delay correlation information due to an increase in the calculation time etc., the advantages of the present disclosure can be obtained.

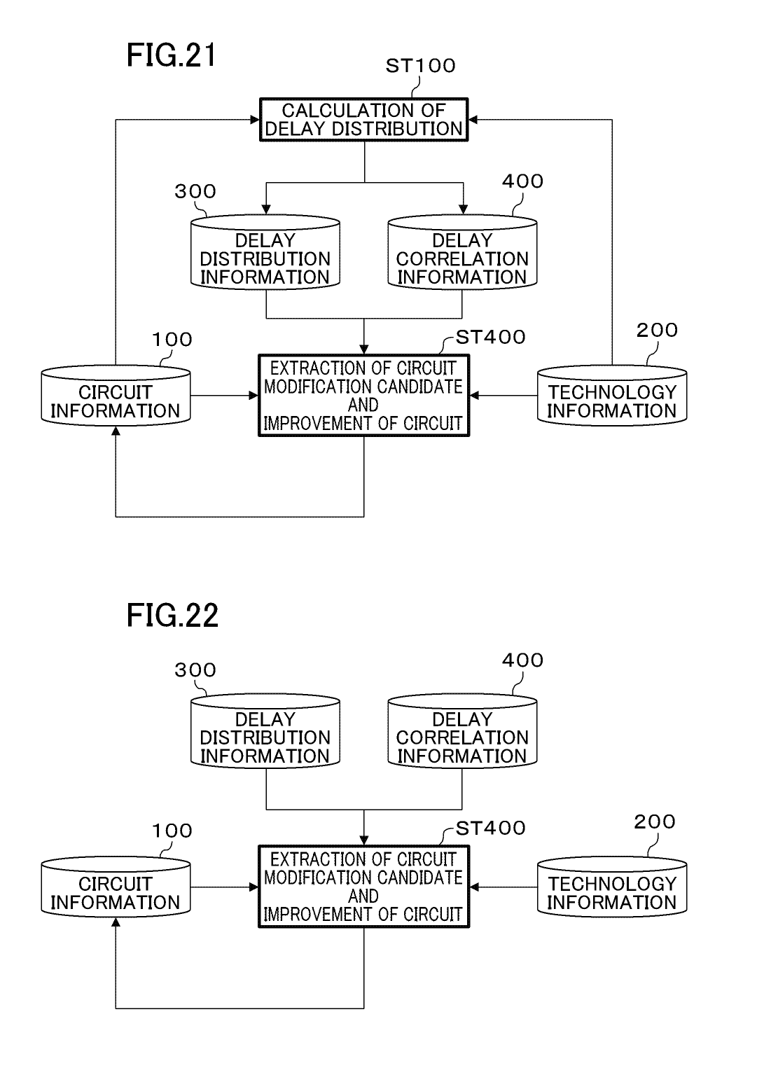

FIG. 21 shows a variation in which, in the process of the embodiment of FIG. 1, the circuit modification candidate extraction process ST200 and the circuit improvement process ST300 are executed as a process ST400 in the same program using the same computer. The circuit modification candidate information 500 may be stored as internal data in a memory of the computer, and does not need to be output as a data file. When the circuit modification candidate information 500 is stored as internal data, particularly, when the circuit modification candidate determination process ST240 and the circuit improvement process ST300 are sequentially executed in the same program using the same computer, the time required to read and write a file can be reduced. On the other hand, when different programs are used, the circuit modification candidate information 500 is more preferably output as a data file.

FIG. 22 shows a variation in which the delay distribution calculation ST100 is removed from the process of the embodiment of FIG. 21. The variation of FIG. 22 has the advantages of the variation of FIG. 18 in addition to the advantages of the variation of FIG. 21.

The present disclosure is useful for the design of a semiconductor integrated circuit, particularly, the improvement of performance of the circuit which is achieved by simulation of circuit characteristics based on of a process information etc. using a computer.

What is claimed is:

1. A method for analyzing a semiconductor integrated circuit, comprising:
obtaining circuit information about a circuit to be designed;
obtaining technology information about a distribution of a characteristic of a device and/or an interconnect based on a process to be designed;
obtaining delay distribution information about a distribution of a delay in the circuit to be designed;
obtaining delay correlation information about a correlation between variations in the delay in the circuit to be designed; and
generating circuit modification candidate information about a circuit modification candidate for improving the delay in the circuit to be designed, based on the circuit information, the technology information, the delay distribution information, and the delay correlation information.

2. The method of claim 1, wherein
the generating the circuit modification candidate information includes
generating a graph representing the circuit to be designed, from the circuit information, using a vertex or vertices and an edge or edges,
first calculating, for each of the edges generated in the generating the graph, a probability that the edge is a critical edge,
second calculating, for each of the vertices and edges generated in the generating the graph, a probability that the vertex or edge is on a critical path, and
generating the circuit modification candidate information based on results of calculation in the first and second calculating.

3. The method of claim 1, further comprising:
modifying the circuit information based on the circuit modification candidate information.

4. The method of claim 1, further comprising:
analyzing a path based on a connection relationship described in the circuit information, and outputting the delay distribution information and the delay correlation information, as a result of analysis of the circuit to be designed based on a result of the path analysis and delay information described in the technology information.

5. The method of claim 1, wherein
the improvement of the delay includes a reduction in a delay violation in the circuit to be designed or a reduction in a maximum delay in the circuit to be designed.

6. The method of claim 1, wherein
the circuit modification candidate information includes at least one cell or interconnect.

7. The method of claim 1, wherein
the delay includes a period of time from a first signal change in a clock or a flip-flop to a second signal change at another vertex in the circuit to be designed, the second signal change being caused by the first signal change.

8. The method of claim 1, wherein
in the generating the circuit modification candidate information, the circuit modification candidate information is generated by extracting a candidate having a high probability that a vertex or an edge is on a critical path, taking into consideration the delay distribution information and the delay correlation information.

9. The method of claim 1, wherein
the delay correlation information includes information about a correlation coefficient for variations in at least one pair of delays.

10. The method of claim 1, wherein
the circuit information is logic circuit information generated by logic synthesis in a logic design process of the semiconductor integrated circuit.

11. The method of claim 1, wherein
the circuit information is arranged circuit information generated after design of arrangement in an arrangement design process of the semiconductor integrated circuit.

12. The method of claim 1, wherein
the circuit information is interconnected circuit information generated after design of interconnects in an interconnect design process of the semiconductor integrated circuit.

13. A circuit analysis program for causing a computer to execute the method of claim 1.
